(19) United States
(12) Patent Application Publication
(10) Pub. No.: US 2023/0010941 A1
(43) Pub. Date: Jan. 12, 2023

(54) DETECTING AN IN-FIELD EVENT

(71) Applicant: RHiot, Inc., Vancouver, WA (US)

(72) Inventor: Jonathan Lovegrove, Yacolt, WA (US)

(21) Appl. No.: 17/369,498

(22) Filed: Jul. 7, 2021

(51) Int. Cl. G06N 20/00; G10L 15/18; G10L 15/06

(52) U.S. Cl. CPC G06N 20/00; G10L 15/1815; G10L 15/063

(57) ABSTRACT

Examples are disclosed that relate to methods, computing devices, and systems for detecting an in-field event. One example provides a method comprising, during a training phase, receiving one or more training data streams. The training data stream(s) include an audio input comprising a semantic indicator. The audio input is processed to recognize the semantic indicator. A subset of data is selected and used to train a machine learning model to detect the in-field event, and the method further comprises outputting the trained machine learning model. During a run-time phase, the method comprises receiving one or more run-time input data streams. The trained machine learning model is used to detect a second instance of the in-field event in the one or more run-time input data streams. The method further comprises outputting an indication of the second instance of the in-field event.

### BACKGROUND

Accurate knowledge of events occurring in a field of operation can be an important aspect of military, emergency response, and commercial operations. An individual or group working in the field may receive broad direction from a leader or dispatcher outside of the field. However, once in the field, the individual or group can make decentralized decisions, which can be challenging to communicate in real-time to those outside of the field. It can also be difficult for individuals or groups outside of the field to respond to an in-field event without situational awareness.

### SUMMARY

According to one aspect of the present disclosure, a method is provided for detecting an in-field event. The method comprises, at a computing device and during a training phase: receiving one or more training data streams. The one or more training data streams include an audio input comprising a semantic indicator corresponding to a first instance of the in-field event. The audio input of the one or more training data streams is processed to recognize the semantic indicator. A subset of data is selected from the one or more training data streams received within a threshold time of the semantic indicator. The subset of the data is used to train a machine learning model to detect the in-field event, and the method further comprises outputting the trained machine learning model. During a run-time phase, the method comprises receiving one or more run-time input data streams. The trained machine learning model is used to detect a second instance of the in-field event in the one or more run-time input data streams. The method further comprises outputting an indication of the second instance of the in-field event.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A shows one example of a field environment.

FIG. 1B shows another example of a field environment.

FIG. 1C shows another example of a field environment.

FIG. 2 shows a schematic diagram of an example system for classifying a target according to one example that may be used to detect in-field events in the field environment of FIG. 1A, the field environment of FIG. 1B, or the field environment of FIG. 1C according to one example embodiment.

FIG. 3 shows one example of a computing device that may be used as the edge computing device of the system of FIG. 2.

FIG. 4 shows one example of a weapon, which may be coupled to the computing device of FIG. 2 and/or used in the field environment of FIG. 1A, the field environment of FIG. 1B, or the field environment of FIG. 1C.

FIGS. 5A-5C show a flowchart of an example method for detecting an in-field event, according to one example embodiment.

FIG. 6 shows an example of two data streams according to one example implementation.

FIG. 7 shows a schematic diagram of one example of a data processing system for detecting an in-field event that can be implemented at the system of FIG. 2.

FIGS. 8A-8F show one example of a computing device that may be used in the field environment of FIG. 1A.

FIG. 9 shows a schematic diagram of an example computing system, according to one example embodiment.

FIG. 10 shows another example of a field environment.

FIG. 11 shows the field environment of FIG. 10 including a non-combatant in the field.

### DETAILED DESCRIPTION

As introduced above, accurate knowledge of events occurring in a field of operation can be an important aspect of military, emergency response, and commercial operations. In some examples, an individual or group working in the field may receive broad direction (e.g., to advance in a direction, to secure an area, or to inspect a piece of equipment) from a leader or dispatcher outside of the field. However, once in the field, the individual or group can make more decentralized decisions.

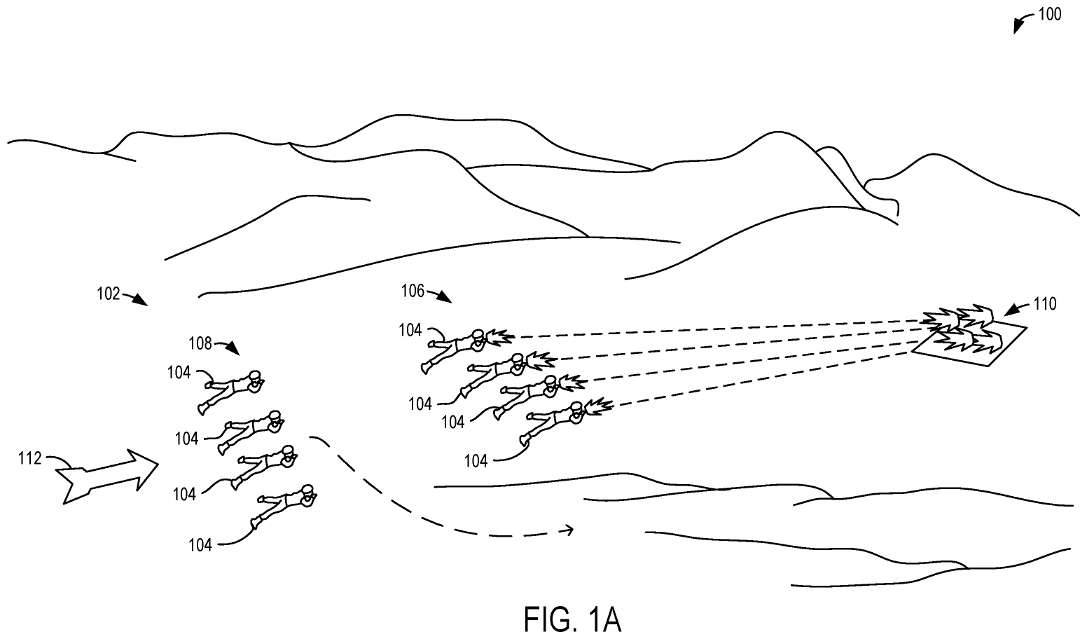

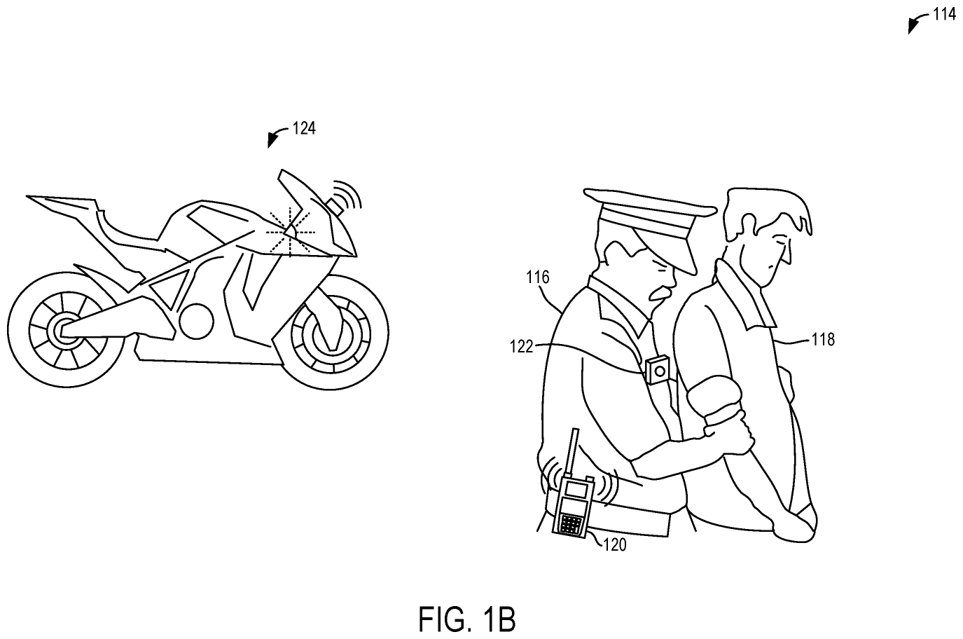

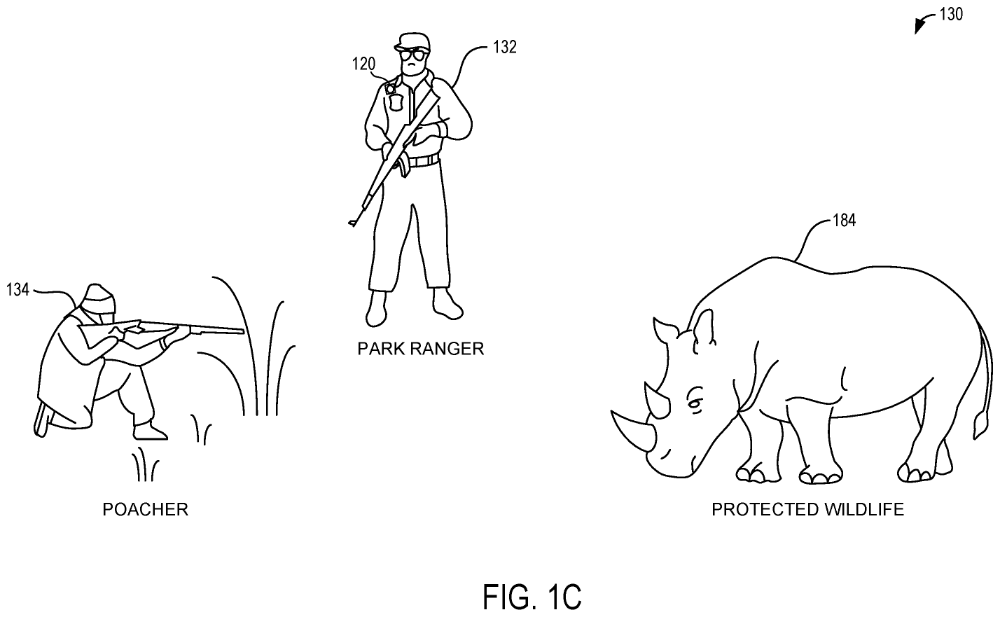

FIG. 1A shows one example of a field environment 100, in which a squad 102 of soldiers 104 (comprising a first team 106 and a second team 108) is engaging an enemy firing position 110. The squad 102 may have broad instructions from a leader who is not in the field environment 100. For example, the squad 102 may be instructed to advance in a northeastern direction 112.

In contrast, once in the field, the squad 102 makes decentralized decisions (e.g., to apply small-unit tactics). For example, each of the soldiers 104 may assume a prone position in response to taking fire from the enemy firing position 110. The first team 106 may provide cover fire for the second team 108 to flank the enemy firing position 110.

However, it can be challenging to communicate these decentralized decisions to those outside the field environment 100. For example, military leaders may base their knowledge of in-field events on verbal status reports provided by the soldiers 104 via radio. It can be difficult to maintain such communication in real time. Communication can be further hindered in stressful situations, such as when the soldiers 104 are taking fire. In addition, a leader outside of the field environment 100 may not be aware of the context of the squad's actions, such as the location of the enemy firing position 110, the locations and formations of the soldiers 104, the soldiers' actions (e.g., firing or bounding), and whether anyone is injured, which can make it difficult for the leader to support the squad 102.

FIG. 1B shows another example of a field environment 114, in which a police officer 116 is arresting a suspect 118. Similarly to the soldiers 104, the police officer 116 may receive instructions from outside the field environment 114. For example, a dispatcher may provide the police officer 116 a location of the suspect 118 via a two-way radio 120. However, events can occur in the field environment 114 that are difficult to communicate to those outside the field environment 114. For example, the police officer 116 may engage in a physical struggle to restrain the suspect 118 if the suspect attempts to escape. The microphone on the radio 120 may capture audio from the environment that includes sounds made by the suspect and the officer, as well as communications from the officer to a command or dispatch center.

FIG. 1C shows yet another example of a field environment 130, in which a park ranger 132 is confronting a suspected poacher 134. Similarly to the soldiers 104 of FIG. 1A and the police officer 116 of FIG. 1B, the park ranger 132 may receive instructions from outside the field environment 130 (e.g., from a dispatch center or command post) and may relay communications back to via a two-way radio 120. For example, the park ranger 132 may be dispatched to protect wildlife such as a rhinoceros 184, for example by confronting a suspected poacher 134. However, like the examples of FIGS. 1A and 1B, it can be difficult to communicate events occurring in the field environment 130. For example, the wildlife may come within view of the ranger, the poacher may attempt to flee or confront the ranger, or the poacher may attempt to shoot the protected wildlife. The microphone on the radio 120 may capture audio from the environment that includes sounds made by the poacher, animal, and ranger, as well as communications from the park ranger to the command or dispatch center.

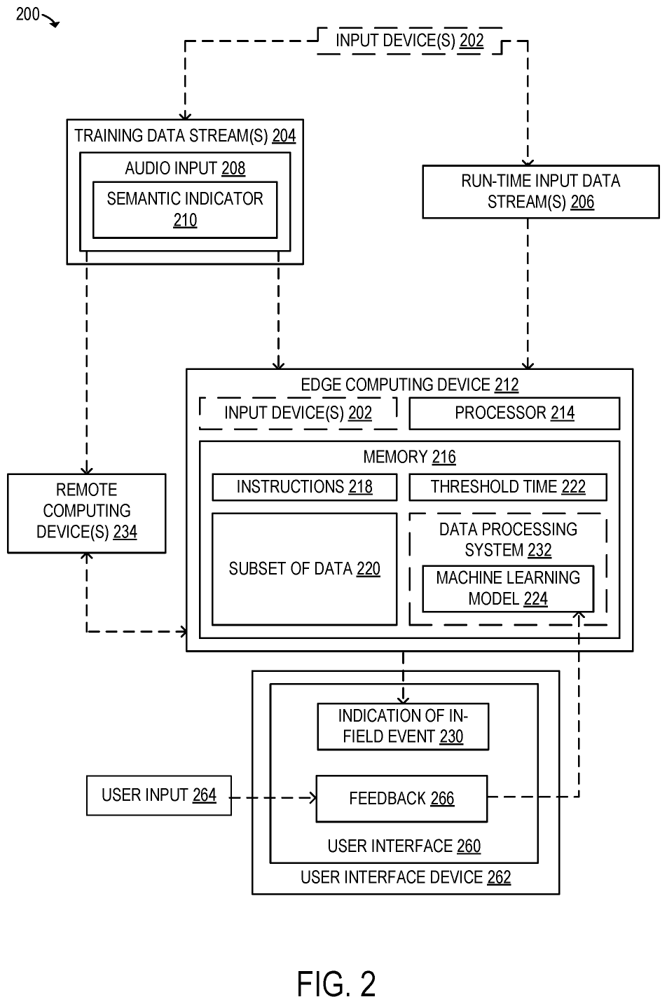

To address the above shortcomings, and with reference now to FIG. 2, a system 200 is provided for detecting an in-field event. The system 200 includes one or more input devices 202 configured to capture one or more training data streams 204 and one or more run-time input data streams 206. As described in more detail below, the one or more training data streams 204 include an audio input 208 comprising a semantic indicator 210 corresponding to a first instance of an in-field event.

The system 200 also includes an edge computing device 212. In some examples, the one or more input devices 202 may be integrated with the edge computing device 212. In other examples, the one or more input devices 202 and the edge computing device 212 comprise separate devices.

The edge computing device 212 further comprises a processor 214 and a memory 216 storing instructions 218 executable by the processor 214. Briefly, the instructions 218 are executable by the processor 214 to, during a training phase, receive the one or more training data streams 204. The audio input 208 of the one or more training data streams 204 is processed to recognize the semantic indicator 210. A subset of data 220 is selected from the one or more training data streams 204 received within a threshold time 222 of the semantic indicator 210. The subset of the data 220 is used to train a machine learning model 224 to detect the in-field event. The instructions are further executable to output the trained machine learning model 224.

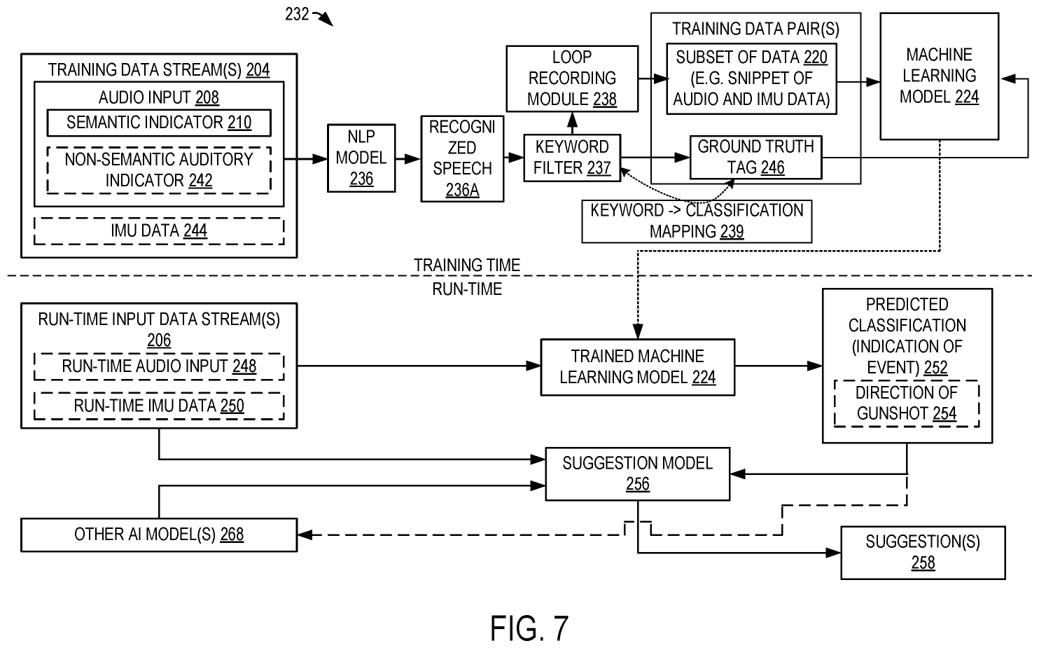

In some examples, the machine learning model 224 is integrated into a data processing system 232. The data processing system 232 can be implemented at the edge computing device 212, one or more remote computing devices 234 (e.g., a cloud server), or any other suitable device or combination of devices disclosed herein. For example, the edge computing device 212 may offload training of the machine learning model 224 to the one or more remote computing devices 234. Additional details regarding the data processing system 232 are provided below with reference to FIG. 7.

With continued reference to FIG. 2, during a run-time phase, the instructions 218 are executable to receive the one or more run-time input data streams 206. The trained machine learning model 224 is used to detect a second instance of the in-field event in the one or more run-time input data streams 206. The instructions 218 are further executable to output an indication 230 of the second instance of the in-field event.

In some examples, the indication 230 of the in-field event is output via a user interface 260 of a user interface device 262. In some examples, the user interface device 262 is a component of the edge computing device 212 or the input device 202. In other examples, the user interface device 262 comprises a separate device.

The user interface device 262 may comprise a communication unit (e.g., a radio), a head-mounted display (HIVID) device, a smart weapon, an in-field computing device (e.g., a smartphone, a tablet, or a laptop computing device), or a remote computing device (e.g., a workstation in a remote command center). It will also be appreciated that the user interface device 262 may comprise any other suitable device or combination of devices.

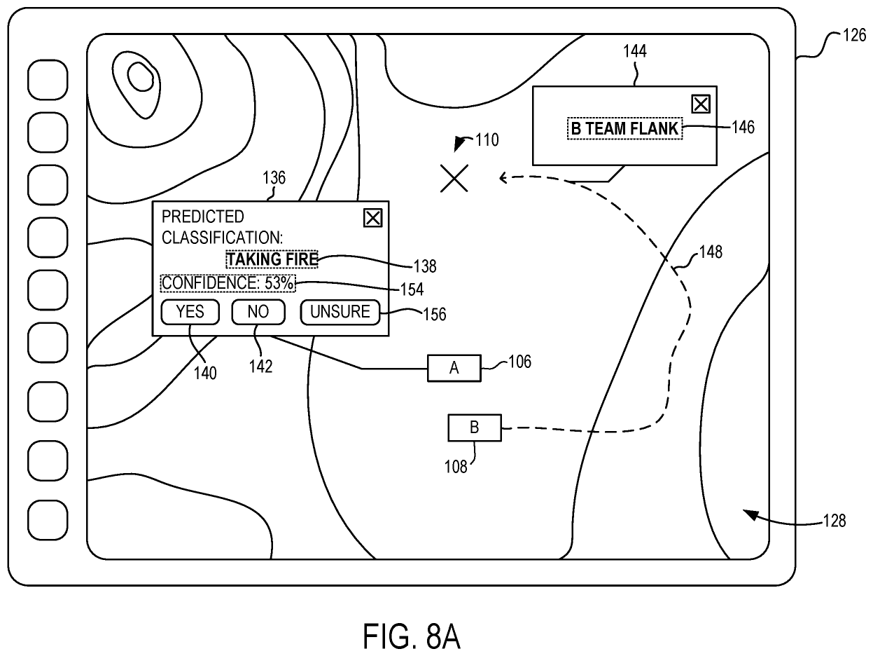

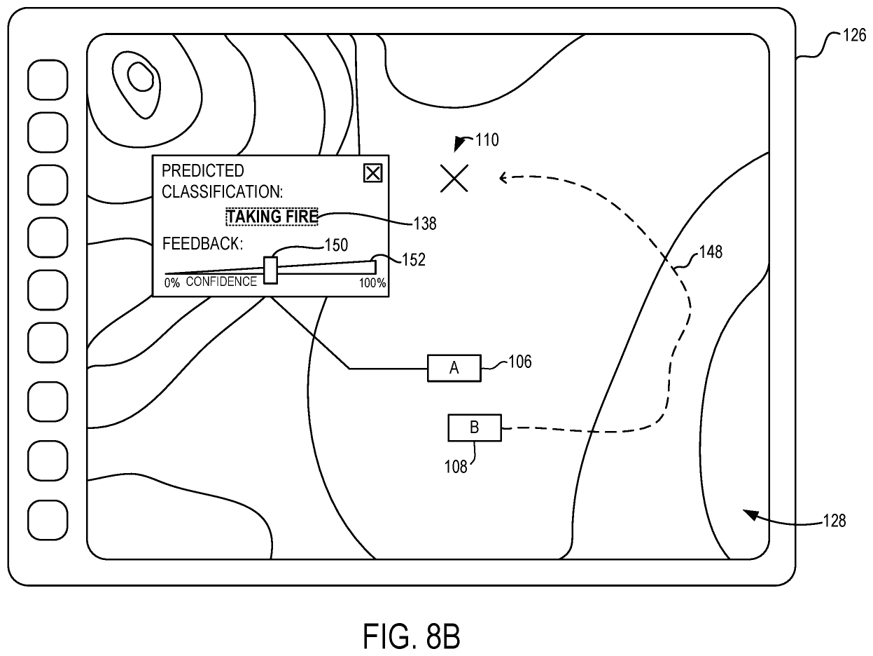

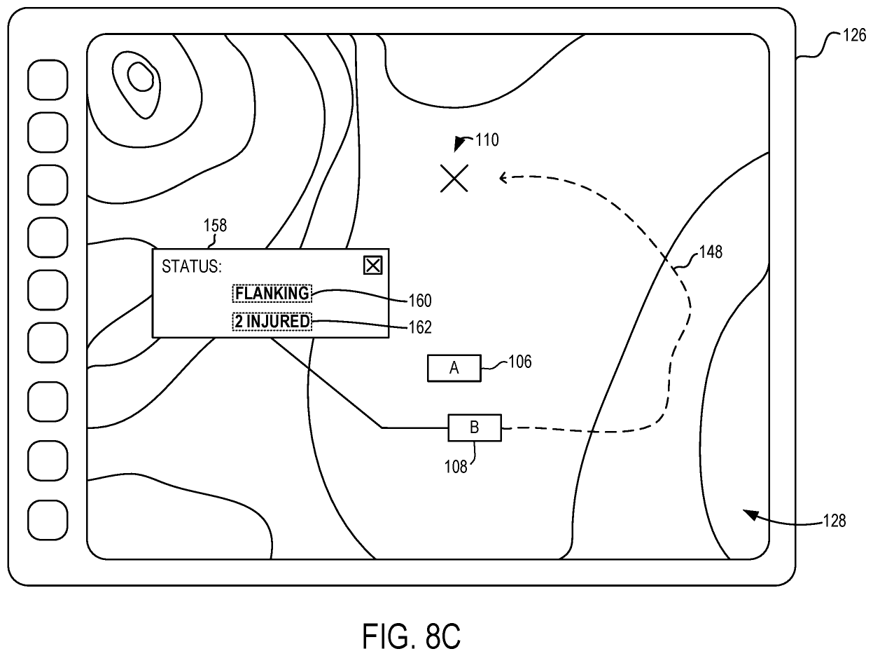

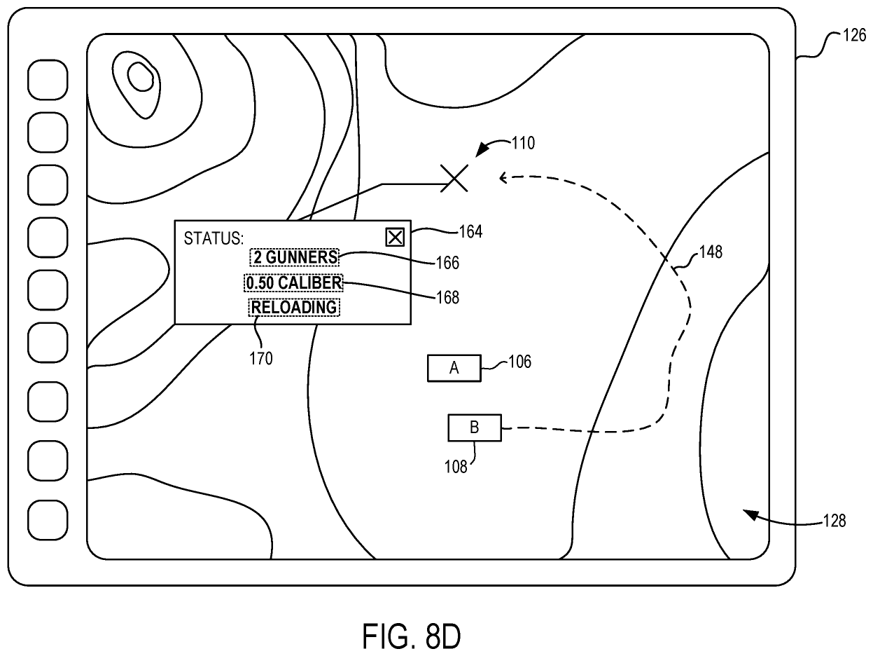

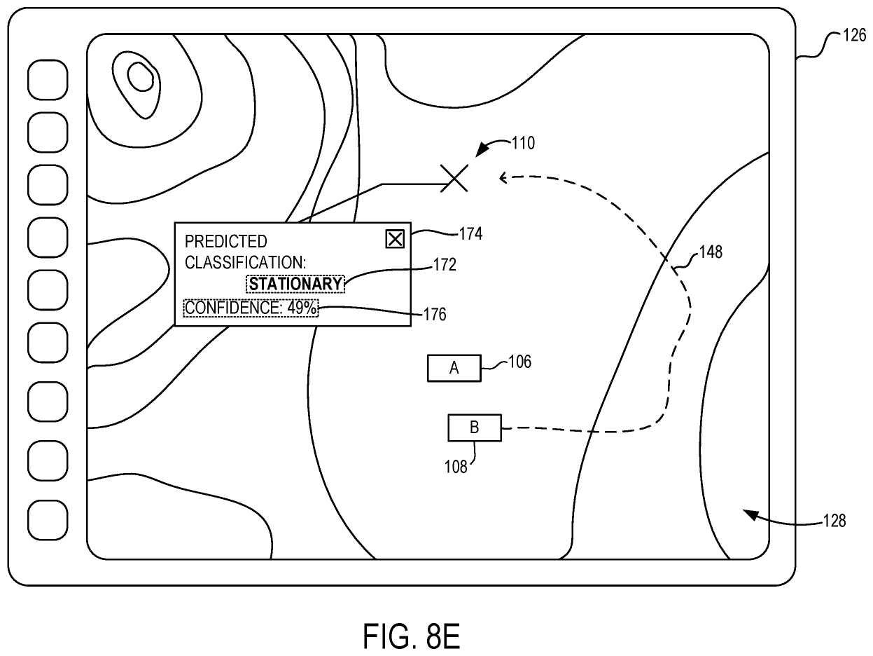

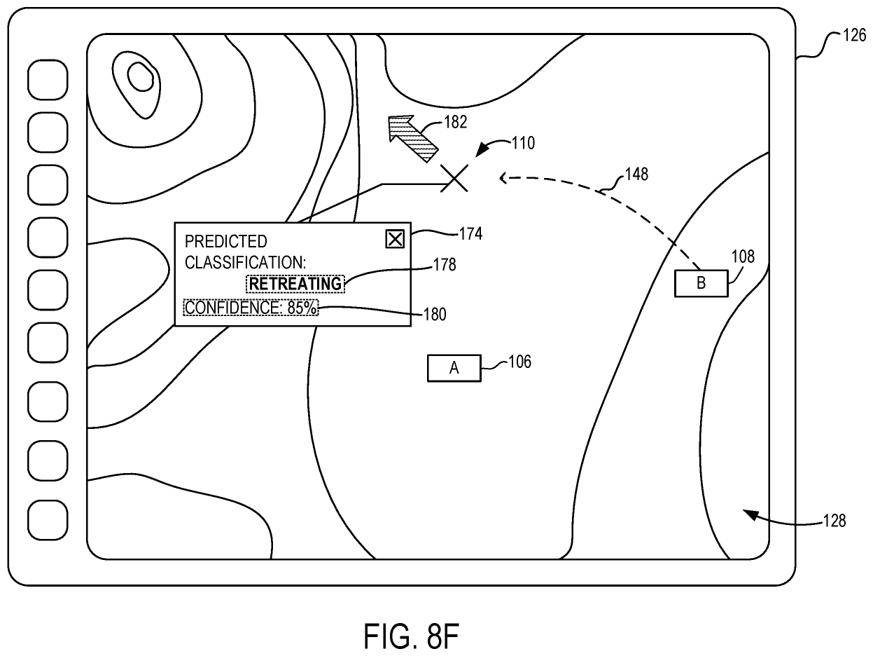

As described in more detail below with reference to FIGS. 8A and 8B, after the indication 230 of the in-field event is output via the user interface 260, a user can provide a user input 264 via the user interface 260. In this manner, the user can provide feedback 266 indicating that the indication 230 was accurate or inaccurate. The feedback 266 is then paired with the run-time input data stream(s) 206 as a feedback training data pair and used to conduct feedback training on the machine learning model 224.

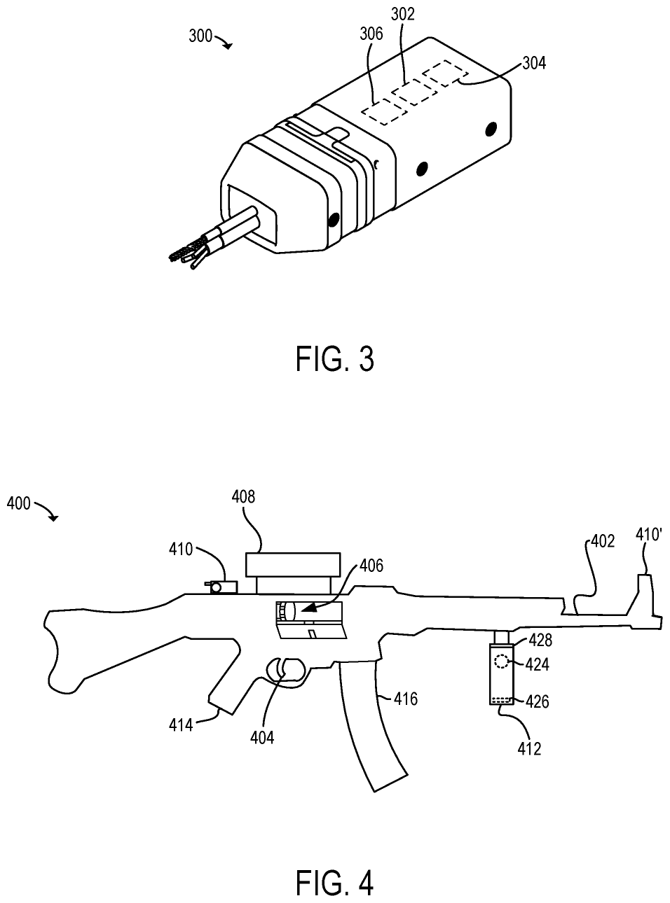

FIG. 3 shows one example of a computing device 300, which may be configured to enact at least a portion of the methods disclosed herein. For example, the computing device 300 can serve as the edge computing device 212 of FIG. 2. In some examples, the computing device 300 may be referred to as an edge computing device. An edge computing device is a computing device having a position on a network topology between a local network and a wider area network (e.g., the Internet).

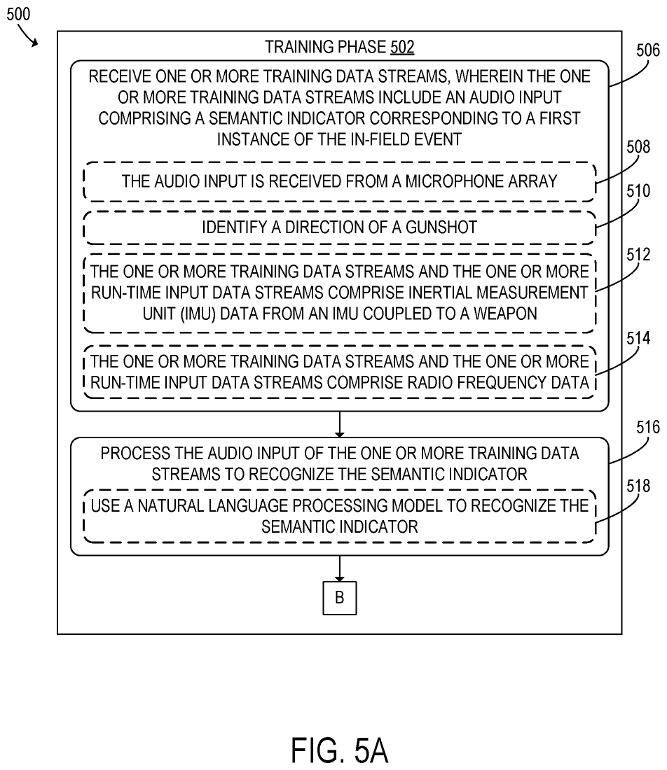

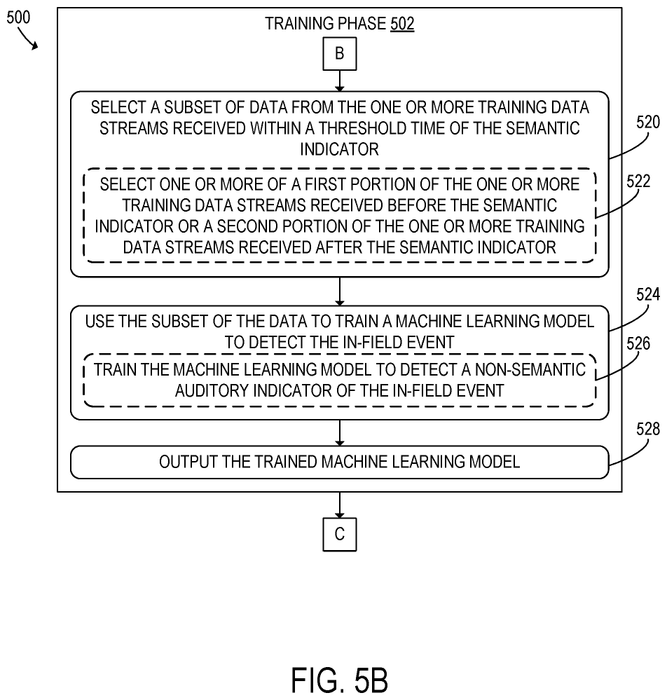

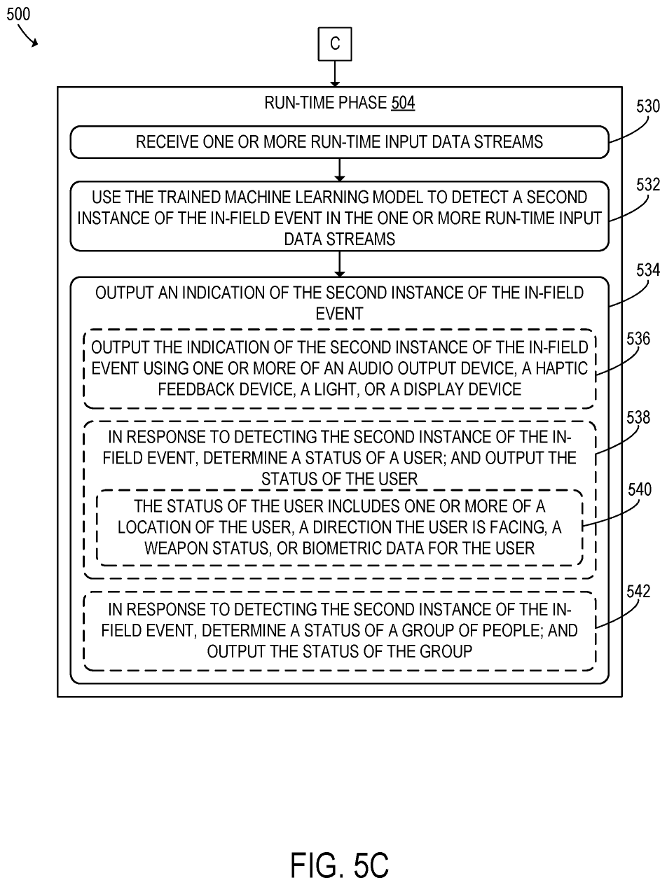

The computing device 300 comprises a processor 302 and a memory 304. In some examples, the computing device 300 further comprises at least one input device 306. In some examples, the at least one input device 306 comprises a microphone or a microphone array. The at least one input device 306 can additionally or alternatively include any other suitable input device or devices. Some examples of suitable input devices include an inertial measurement unit (IMU), a global positioning system (GPS) sensor, an antenna, a thermometer, a heart rate monitor, a pulse oximeter, a skin galvanometer, and one or more cameras. As described in more detail below with reference to FIGS. 5A-5C, data captured by the at least one input device can be used to train a machine learning model to predict an in-field event, and to predict the in-field event in a run-time environment.

In some examples, and with reference now to FIG. 4, a computing device and/or one or more input devices may be coupled to a weapon 400. The weapon 400 comprises a barrel 402, a trigger 404, and a firing mechanism 406. The weapon 400 further comprises visual alignment aids in the form of an optical scope 408 and iron sights 410 and 410′. The weapon 400 further comprises a foregrip 412 and a trigger grip 414. In some examples, the computing device is integrated inside of the foregrip 412 or the trigger grip 414. In other examples, the computing device can be affixed to the weapon 400 as an accessory. For example, the computing device can be mounted to the weapon 400 via a Picatinny rail system (e.g., according to United States Military Standard MIL-STD-1913).

With reference now to FIGS. 5A-5C, a flowchart is illustrated depicting an example method 500 for detecting an in-field event. The following description of method 500 is provided with reference to the software and hardware components described above and shown in FIGS. 1-4 and 6-9. In some examples, the method 500 may be performed at the edge computing device 212 of FIG. 2, the computing device 300 of FIG. 3, the weapon 400 of FIG. 4, or any other suitable device or combination of devices disclosed herein. It will be appreciated that method 500 also may be performed in other contexts using other suitable hardware and software components.

It will be appreciated that the following description of method 500 is provided by way of example and is not meant to be limiting. It will be understood that various steps of method 500 can be omitted or performed in a different order than described, and that the method 500 can include additional and/or alternative steps relative to those illustrated in FIGS. 5A-5C without departing from the scope of this disclosure.

The method 500 includes a training phase 502 and a run-time phase 504. In some examples, the training phase 502 occurs in a training environment and the run-time phase 504 occurs in a deployed field environment. For example, the training phase 502 may occur while the soldiers 104 of FIG. 1A are in a field training exercise (FTX) or military training school, and the run-time phase 504 may occur while the soldiers 104 are deployed in the field environment 100. As another example, the training phase may occur while the police officer 116 of FIG. 1B is in a police academy or training class, and the run-time phase may occur while the police officer 116 is working in the field environment 114.

In other examples, at least a portion of the training phase 502 and the run-time phase 504 may occur concurrently or in the same environment. For example, the machine learning model 224 of FIG. 2 may comprise a continual learning model that can learn and adapt during the run-time phase, based on feedback received from the user.

At 506, the method 500 comprises, during the training phase, receiving one or more training data streams. As described in more detail below, the one or more training data streams include an audio input comprising a semantic indicator corresponding to a first instance of the in-field event.

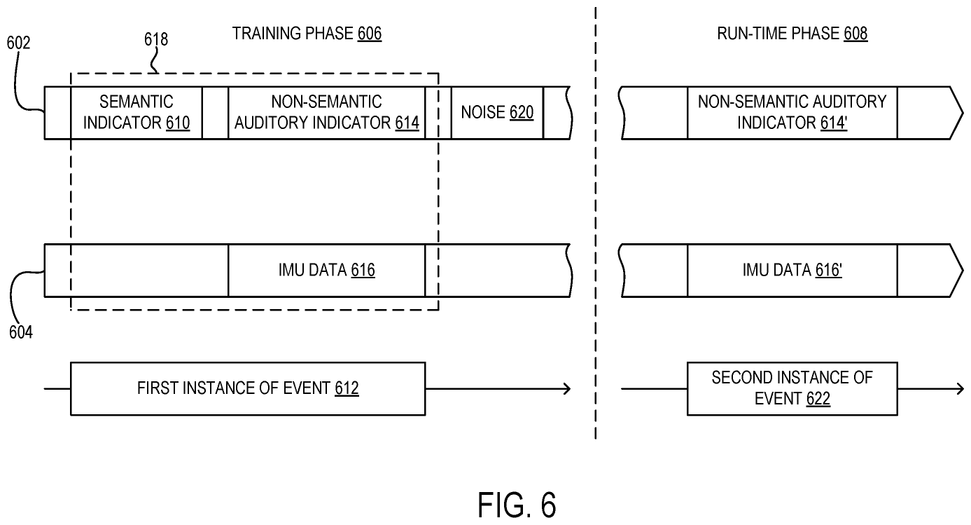

FIG. 6 shows an example of two data streams that can serve as two training data streams during a training phase, and subsequently serve as two run-time input data streams during a run-time phase following the training phase. The input data streams include an audio input data stream 602 and an IMU input data stream 604. In other examples, the one or more training data stream(s) and the one or more run-time input data stream(s) may comprise different input data streams, which may additionally or alternatively be received from different devices.

The audio input data stream 602 can be obtained from a microphone associated with one or more of the soldiers 104 of FIG. 1A. For example, the audio input data stream 602 can be obtained from a microphone worn or carried by one of the soldiers 104, or from a microphone integrated with the weapon 400 of FIG. 4. As another example, the audio input data stream can be obtained from the radio 120 of FIG. 1B or a microphone integrated with a body camera 122 worn by the police officer 116.

In some examples, and as indicated at 508 of FIG. 5A, the audio input may be received from a microphone array comprising a plurality of microphones. The microphone array may provide directional sound information. For example, and as indicated at 510, when the in-field event comprises a gunshot, the method may include identifying a direction of the gunshot (e.g., using the directional sound information provided by the plurality of microphones).

At 512, the one or more training data streams and the one or more run-time input data streams may include IMU data. In some examples, and as described in more detail below, the IMU data may be obtained from an IMU coupled to a weapon. For example, the IMU input data stream 604 of FIG. 6 can be obtained from an IMU integrated with the weapon 400 of FIG. 4. In other examples, the IMU input data stream 604 can be obtained from an IMU worn or carried by one or more of the soldiers 104 of FIG. 1A or the police officer 116 of FIG. 1B.

As another example, the one or more training data streams and the one or more run-time input data streams may include radio frequency (RF) data, as indicated at 514 of FIG. 5A. The RF data can be used to determine that one or more RF channels are being jammed. The RF data can also be used to determine that one or more RF channels are open for communication.

As yet another example, the one or more training data streams and the one or more run-time input data streams may include biometric data. For example, a soldier's heart rate may accelerate in response to enemy contact, or a police officer's breathing may become more rapid and heavy than normal while engaging in a physical struggle with a suspect. In other examples, IMU data indicating that the soldiers 104 of FIG. 1A have rapidly assumed a prone position, coupled with biometric data indicating that one or more of the soldiers 104 have started sweating and have an increased heart rate, can be correlated with the soldiers 104 taking fire.

With reference again to FIG. 6, and as introduced above, the audio input data stream 602 includes a semantic indicator 610 corresponding to a first instance 612 of an in-field event. In some examples, the semantic indicator 610 comprises a verbal utterance. For example, a soldier may shout “incoming”, “contact”, or the like in response to taking fire. As another example, a police officer may say “10-99”, “officer in need of assistance”, or the like in response to engaging in a physical struggle with a suspect. In other examples, the semantic indicator 610 may comprise one or more non-verbal cues (e.g., patterns of speech or intonation) that encode a linguistic or logical meaning. For example, a profanity shouted in response to a gunshot may have a higher implied urgency than the same profanity uttered in a different context (e.g., running out of water).

While FIG. 6 depicts the semantic indicator 610 as received concurrently with and at the beginning of the first instance 612 of the in-field event, it will also be appreciated that the semantic indicator 610 may be received at any other suitable time. For example, the semantic indicator 610 may be received before or after the first instance 612 of the in-field event, or concurrently with any other suitable portion of the event.

In some examples, the in-field event can be identified based upon the semantic indicator 610. However, the semantic indicator 610 may not always accompany the in-field event. In the example of FIG. 6, the semantic indicator 610 accompanies the first instance 612 of the in-field event, but not a second instance 622 of the in-field event. This may occur because, for example, events may occur too quickly for individuals to verbalize in a deployed field environment, or the individuals can be otherwise occupied (e.g., addressing an emergency or getting themselves to safety) and may not semantically describe what is happening in real-time. In other examples, the semantic indicator may be unintelligible to a computing device.

However, other inputs may also accompany the in-field event. For example, the audio input data stream 602 may include one or more non-semantic auditory indicators 614 corresponding to the first instance 612 of the in-field event. For example, incoming small-arms fire may be accompanied by the sound of a bullet passing through the air or impacting an object. A microphone worn by a soldier may also capture the sound of the soldier dropping into a prone position in response to enemy contact (e.g., the sound of the soldier colliding with the ground). Similarly, a microphone worn by a police officer may capture non-semantic sounds of a physical struggle with a suspect (a collision between the officer and the suspect, the sounds of punches or kicks, heavy breathing, etc.), or sound coming from a siren of a police vehicle.

While FIG. 6 depicts the non-semantic auditory indicator 614 following the semantic indicator 610, it will be appreciated that the non-semantic auditory indicator 614 may be received at any other suitable time. For example, the non-semantic auditory indicator 614 may additionally or alternatively occur before or concurrently with the semantic indicator 610. It will also be appreciated that the non-semantic auditory indicator 614 may be received before or after the first instance 612 of the in-field event, or concurrently with any other suitable portion of the event.

The IMU input data stream 604 can include IMU data 616 corresponding to the first instance 612 of the in-field event. For example, the IMU data 616 may include acceleration data indicating that the soldier has collided with the ground, or that the police officer has collided with the suspect.

While FIG. 6 depicts the IMU data 616 being received concurrently with the non-semantic auditory indicator 614, it will be appreciated that the non-semantic auditory indicator 614 may be received at any other suitable time. For example, the IMU data 616 may additionally or alternatively occur before or after the non-semantic auditory indicator 614.

One or more of the non-semantic auditory indicator 614 or the IMU data 616 may comprise a signature that distinguishes the in-field event from other types of events. For example, the combination of the non-semantic auditory indicator 614 and the IMU data 616 may be different when a subject is engaged in a fight than when the subject has tripped and fallen. In this manner, and as described in more detail below, a machine learning model may be trained to detect the in-field event based upon one or more of the audio input data stream 602 or the IMU input data stream 604.

Accordingly, and with reference again to FIG. 5A, at 516, the method 500 includes processing the audio input of the one or more training data streams to recognize the semantic indicator. For example, as indicated at 518, a natural language processing (NLP) model may be used to recognize the semantic indicator. The NLP model is described in more detail below with reference to FIG. 7.

FIG. 7 schematically illustrates an example configuration of the data processing system 232 that can be used for detecting an in-field event. As described above with reference to FIG. 2, the data processing system 232 may be implemented at the edge computing device 212, the one or more remote computing device(s) 234, or any suitable device or combination of devices disclosed herein.

The data processing system 232 is configured to receive the one or more training data streams 204. As described above, the one or more training data streams 204 include an audio input 208 comprising a semantic indicator 210 corresponding to a first instance of the in-field event. The audio input 208 is provided to an NLP model 236 configured to recognize the semantic indicator 210. In some examples, the NLP model 236 comprises a convolutional neural network configured to identify and extract natural language from the audio input 208. It will also be appreciated that any other suitable methods may be used to recognize the semantic indicator 210.

As indicated at 520 of FIG. 5B, a subset of data is selected from the one or more training data streams that is received within a threshold time of the semantic indicator. In the example of FIG. 7, the NLP model 236 may output an indication, to a loop recording module 238, that the semantic indicator 210 has been recognized. The loop recording module 238 is configured to record the one or more training data streams 204. In response to receiving the indication that the semantic indicator 210 has been recognized, the loop recording module 238 may output a subset of data 220 that is received within the threshold time of the semantic indicator 210.

For example, the subset of data can include one or more of a first portion of the one or more training data streams received before the semantic indicator or a second portion of the one or more data streams received after the semantic indicator, as indicated at 522 of FIG. 5B. In the example of FIG. 6, the subset of the data may comprise a portion 618 of the audio input data stream 602 and the IMU input data stream 604 that is received within a threshold time (e.g., 10 seconds) after the semantic indicator 610 (e.g., an utterance by a user) begins. The subset of the data may additionally or alternatively include a portion of the input data received before the semantic indicator 610.

In this manner, the audio input data stream 602 and the IMU input data stream 604 may be filtered before undergoing further processing. In this manner, downstream processing may be made more efficient by utilizing a subset of the incoming input data streams. In addition, extraneous data that is not correlated with the in-field event, such as noise 620, may be filtered out.

With reference again to FIG. 5B, at 524, the method 500 includes using the subset of the data to train a machine learning model to detect the in-field event. In the example of FIG. 7, the subset of data 220 is used to train the machine learning model 224 to detect the in-field event.

For example, and as indicated at 526 of FIG. 5B, the machine learning model may be trained to detect a non-semantic auditory indicator of the in-field event. In the example of FIG. 7, the machine learning model 224 may be trained to detect non-semantic auditory indicator 242 (e.g., the non-semantic auditory indicator 614 of FIG. 6). The machine learning model 224 may be additionally or alternatively trained to detect IMU data 244 corresponding to the in-field event (e.g., the IMU data 616 of FIG. 6).

In some examples, the semantic indicator 210 is translated by the NLP model 236 into a ground truth tag 246 that is used as a training label for the subset of data 220. As shown, the NLP model 236 process the audio input 208 to produced recognized speech 236A, which in turn is filtered by a keyword filter 237 that passes through keywords that are known to be related to classification of candidate in-field events. The keywords passed by the keyword filter 237 are sent to a keyword classification mapping module 239, which provides a mapping of keywords to ground truth classifications of the in-field events. In this manner, the one or more training data stream(s) 204 can be paired with a ground-truth classification to train the machine learning model 224 to properly classify the one or more run-time input data stream(s) 206 into one or more classifications of in-field events (e.g., gunshot, taser deployment, etc.). For example, an audio stream may include several staccato sounds that are difficult to distinguish with confidence as a gunshot or firework. By training the AI model to recognize sounds that are accompanied in the audio input 208 by semantic indicators 210 as determined by the recognized speech 236A such as “taking fire”, the machine learning model can be trained to properly discriminate between the gunshot and firework sounds. Similarly, a pursuit, scuffle, suspect sighting, or arrest may be difficult to discriminate based on audio inputs alone, but non-semantic audio indicators 242 of such events may be learned by tagging such events with ground truth tags based on semantic indicators 210 such as “in pursuit,” “restraining suspect,” “that's him!” or “you're under arrest” in this manner.

Similarly, it can be difficult to identify an in-field event and to determine targeting data associated with the in-field event with confidence given scant input data. However, the confidence can be increased by one or more additional inputs. For example, one report of a soldier 104 in the environment 100 of FIG. 1A taking fire may be corroborated by drone or satellite footage of the environment 100 showing the enemy firing position 110 and/or one or more streams of audio data indicating one or more gunshots originating from a common location (e.g., the enemy firing position 110). As described in more detail below with reference to FIG. 7, disparate data sources may also be used to infer an appropriate response to the in-field event.

In other examples, the machine learning model 224 may be trained using other ground truth data generated by one or more human operators or synthetic techniques. For example, in another approach, the human operators may take video surveillance data from body cams with ground truth tags of in-events such as pursuit, scuffle, suspect sighting or arrest based on their perception of the video and audio, and the machine learning model 224 may be trained to predicted in-field events of such classifications, based on an input of both the semantic indicator (recognized speech or other sounds carrying a linguistic or logical meaning) and non-semantic indicators in the audio data and the IMU data as a concatenated input vector. As another example, the ranger 132 or scientists observing the field environment 130 of FIG. 1C can provide audio or video footage of the rhinoceros 184 along with a ground truth tag indicating the presence of the rhinoceros 184, such as “look at that” or “there it is”.

At 528, the method 500 includes outputting the trained machine learning model. For example, the edge computing device 212 of FIG. 2 may offload training of the machine learning model 224 to the one or more remote computing devices 234. Accordingly, the one or more remote computing devices 234 may return one or more parameters of the trained machine learning model 224 to the edge computing device 212, which may implement the trained machine learning model 224 at runtime.

With reference now to FIG. 5C, during the run-time phase 504, the method 500 includes, at 530, receiving one or more run-time input data streams. For example, the machine learning model 224 may receive the one or more run-time input data stream(s) 206. For example, the one or more run-time input data stream(s) 206 may include run-time audio input 248 and run-time IMU data 250. As described above, the run-time audio input 248 and run-time IMU data 250 can be received from the same device or devices as the one or more training data stream(s) 204. In the example of FIG. 6, the run-time audio input and run-time IMU data may comprise at least a portion of the audio input data stream 602 and at least a portion of the IMU input data stream 604 received during the run-time phase 608, respectively.

At 532, the method 500 includes using the trained machine learning model to detect a second instance of the in-field event in the one or more run-time input data streams. In the example of FIG. 6, the second instance 622 of the in-field event may be accompanied by non-semantic auditory indicator 614′ and IMU data 616′, which are substantially similar to the non-semantic auditory indicator 614 and the IMU data 616 (e.g., the non-semantic auditory indicator 614′ and the IMU data 616′ are within the same feature space of the trained machine learning model as the non-semantic auditory indicator 614 and the IMU data 616). Accordingly, the trained machine learning model (e.g., the machine learning model 224) can detect the second instance of the in-field event.

Next, at 534, the method 500 of FIG. 5C comprises outputting an indication of the second instance of the in-field event. For example, and with reference again to FIG. 7, the machine learning model 224 is configured to output a predicted classification, which is an indication 252 of an inferred event. When the in-field event comprises a gunshot, the indication 252 can include an indication of a direction 254 of the gunshot (e.g., determined using directional sound information as described above).

The indication 252 may be output to any suitable device or devices. For example, the indication 252 may be output for display to military leaders, emergency response coordinators, and others who may not be able to directly observe a field environment. In other examples, the indication 252 may be output to a server computing device configured to develop and maintain a digital model of the field environment. In yet other examples, the indication 252 may be output to one or more user devices (e.g., to the weapon 400 of FIG. 4). In this manner, the AI system may help to enhance users' situational awareness.

In some examples, the indication 252 can be output to a user device using any suitable output device or devices. For example, as indicated at 536, the indication can be output using one or more of an audio output device, a haptic feedback device, a light, or a display device. For example, and with reference again to FIG. 4, the weapon 400 comprises an audio output device in the form of a speaker 424, a haptic feedback device in the form of a linear resonant actuator 426, and a light 428. One or more of the speaker 424, the linear resonant actuator 426, or the light 428 can be actuated in response to receiving an indication of an in-field event, thereby notifying a user of the event.

In some examples, it can be desirable to communicate a status of an individual or a group in response to detecting an in-field event. In the example of FIG. 1A, a military leader, a medic, or another individual outside of the field environment 100 may want status information for the soldiers 104 in response to receiving a notification that they are taking fire from the enemy firing position 110 (e.g., to determine if anyone is injured and what actions are being taken in response). In the example of FIG. 1B, a police supervisor or dispatcher may want to know a status of the police officer 116 in response to receiving a notification that they are engaging the suspect 118.

Accordingly, and with reference again to FIG. 5C, the method 500 may include, at 538, in response to detecting the second instance of the in-field event, determining a status of a user and outputting the status of the user. In some examples, the status includes one or more of a location of the user, a direction the user is facing, a weapon status, or biometric data for the user, as indicated at 540. It will also be appreciated that, while these examples of status information are described with respect to an individual user, the status information can additionally or alternatively describe a status of a group of people, as indicated at 542.

In the example of FIG. 1A, the status information can include a location of each of the soldiers 104, a location of the first team 106, a location of the second team 108, or a location of the squad 102. The status information can additionally or alternatively include a direction that the soldiers 104, the first team 106, the second team 108, and/or the squad 102 is facing.

In the example of FIG. 1B, the status information can include a location of the police officer 116 or a location of a police vehicle 124. The status information can additionally or alternatively include a direction that the police officer 116 is moving, or a live feed from the body camera 122 or radio 120.

As introduced above, the status information can additionally or alternatively include weapon status information. For example, the status information can include a location of the weapon 400 of FIG. 4, a direction that the weapon 400 is pointed, whether the weapon 400 is jammed, whether the weapon 400 is in a safe or firing mode, an indication of a discharge, an indication that a user's finger is on the trigger 404, and/or how much ammunition remains in a magazine 416.

With reference again to FIGS. 1A and 1B, one or more of the soldiers 104 or the police officer 116 may be equipped with one or more biometric sensors, such as a heart rate monitor, a pulse oximeter, a skin galvanometer, or a body temperature sensor. In this manner, the status information can include biometric data for the one or more soldiers 104 or the police officer 116.

In some examples, the status information can indicate that the first team 106 is in a prone position and is providing cover fire while the second team 108 is bounding to flank the enemy firing position 110. As another example, the status information can indicate that the police officer 116 has apprehended the suspect 118. The status information can additionally or alternatively indicate that one or more of the soldiers 104 or the police officer 116 are injured, and the nature of their injuries. It will also be appreciated that the status information can include any other suitable type of information.

With reference again to FIG. 7, in some examples, the data processing system 232 includes a suggestion model 256. The suggestion model 256 is configured to, in response to detecting the in-field event, generate and output one or more suggestions 258 for a user to respond to the event.

For example, the suggestion model 256 may output a suggestion for the second team 108 of FIG. 1 to flank the enemy firing position 110, for the squad 102 to withdraw, for a commander to send reinforcements, call for fire, and/or call for air support. In this manner, the system 200 of FIG. 2 can help users outside of the field environment and/or in the field environment respond to in-field events.

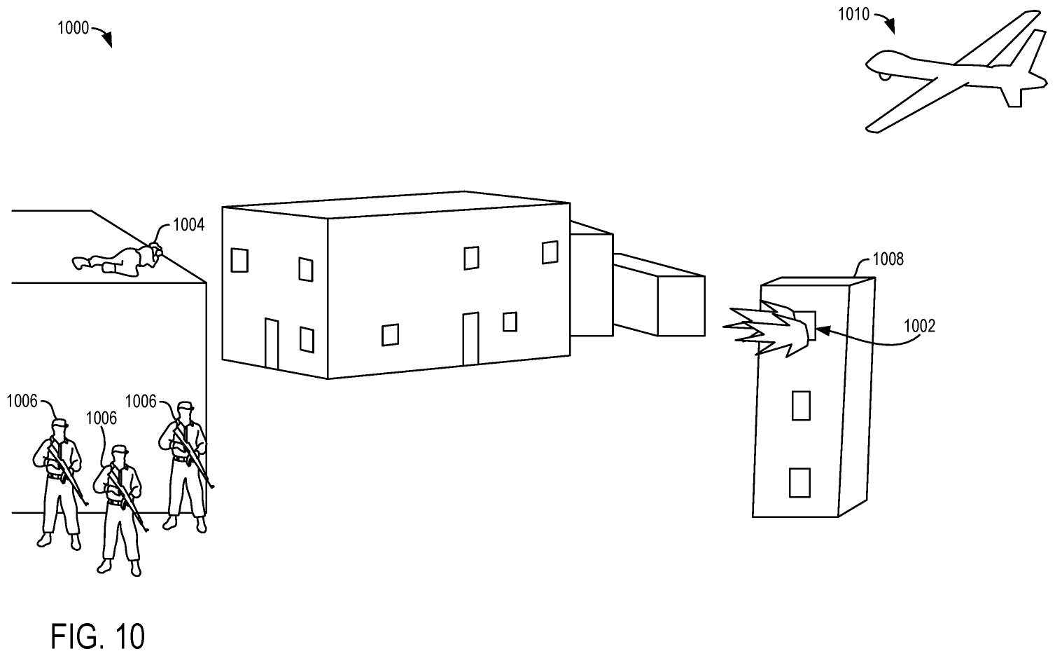

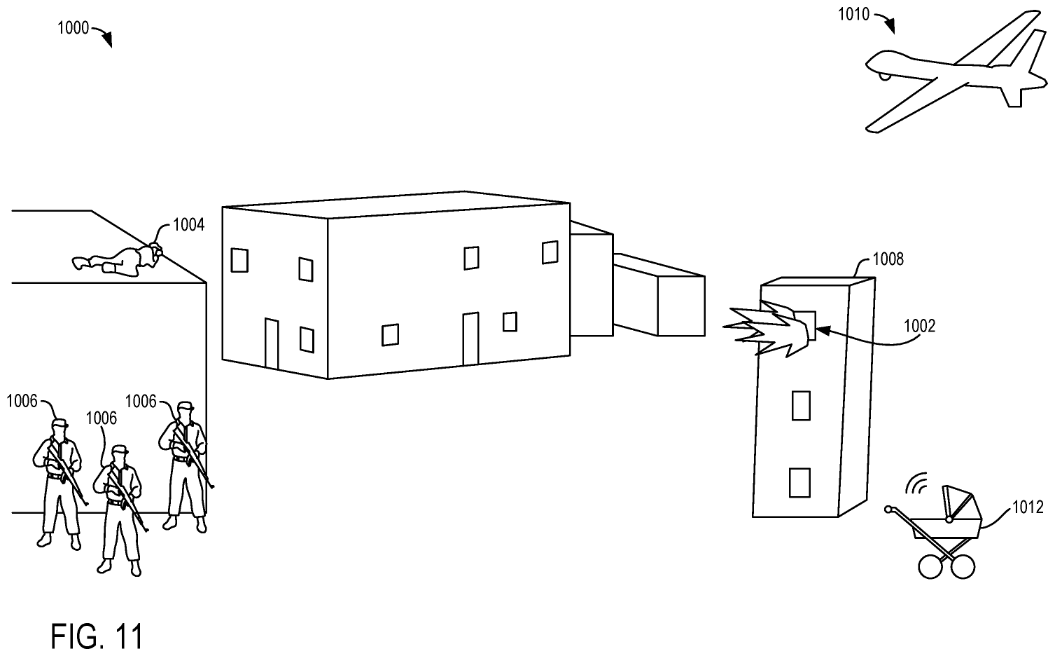

In some examples, the suggestion model 256 receives additional inputs from one or more other purpose-built AI models 268. For example, the AI model(s) 268 may be trained to make predictions based upon one or more disparate data sources, and those predictions are output to the suggestion model 256. In this manner, the suggestion model may use a plurality of different information sources to infer an appropriate response to the in-field event. As described in more detail below with reference to FIGS. 10 and 11, the one or more suggestions 258 output by the suggestion model 256 can be refined based upon proximity of a target to one or more other points of interest (e.g., proximity of the enemy firing position 110 to the soldiers 104).

The one or more other AI model(s) 268 may be configured to further refine the outputs of the data processing system 232. For example, the trained machine learning model 224 may output a predicted classification 252 indicating whether a gunshot has occurred or not. As introduced above, the indication may include a direction of the gunshot 254 (e.g., as triangulated using a non-neural-network-based calculation). The output classification can be fed back into the one or more other AI model(s) 268 to further classify the in-field event. For example, given a plurality of gunshots, the other AI model(s) 268 may be trained to determine a likelihood that the predicted in-field event is correct (e.g., a gunshot rather than a tree branch cracking), which may be influenced by a number of observations (e.g., whether one or 10 different inputs corroborate that a gunshot occurred). The other AI model(s) 268 may additionally or alternatively determine whether a plurality of gunshots originated from one common location, or from different locations; whether there is one shooter or multiple shooters; a type of weapon; and/or a caliber of the weapon. In this manner, the AI model(s) 268 may be used to refine the predicted classification 252 and improve the quality of the output suggestion(s) 258.

The one or more suggestions 258 may be output in any suitable manner. For example, the one or more suggestions 258 may be displayed via a display device (e.g., a computer display screen or a head-mounted display device) or provided to a user as audio feedback (e.g., via a speech interface). Additional details of one example implementation are described in more detail below with reference to FIGS. 8A-8F.

FIG. 8A depicts a computing device in the form of a tablet computing device 126 that can be used in the field environment 100 of FIG. 1A. For example, the tablet computing device 126 can be carried by one of the soldiers 104. As another example, the tablet computing device 126 can be monitored in a remote command center that is outside the field environment 100.

In some examples, the tablet computing device 126 can serve as the edge computing device 212 of FIG. 2. In other examples, the tablet computing device 126 can communicate with one or more remote devices to receive input from a user or provide output to the user.

In the example of FIG. 8A, the tablet computing device 126 is displaying a contour map 128 that depicts the field environment 100 of FIG. 1A. The map 128 indicates a location of the enemy firing position 110, a location of the first team (“A”) 106 and a location 11 of the second team (“B”) 108.

The tablet computing device 126 is further configured to display an indication of an in-field event to the user. For example, in response to taking fire from the enemy firing position 110, the tablet computing device 126 may display a dialog box 136 including indication text 138 describing the in-field event (e.g., “TAKING FIRE”).

In some examples, the dialog box 136 may also display a confidence level 154 for the predicted in-field event. In the example of FIG. 8A, the displayed confidence level 154 indicates that the machine learning model is 53% confident that the first team 106 is taking fire. The dialog box 136 may additionally or alternatively include a color-coded indication of the confidence level. In some examples, the dialog box 136, the indication text 138, and/or the displayed confidence level 154 may have a color that is based upon the confidence level. For example, the dialog box 136, the indication text 138, and/or the displayed confidence level 154 may be displayed in a first color (e.g., red) when the confidence level is less than a threshold confidence level (e.g., 83%). The dialog box 136, the indication text 138, and/or the displayed confidence level 154 may be displayed in a second color (e.g., green) when the confidence level is greater than or equal to the threshold confidence level. In this manner, the dialog box 136 may provide a convenient visual indication of the confidence of the predicted event. The tablet computing device 126 may also be configured to receive feedback for the indicated in-field event. For example, the dialog box 136 may include a “YES” selector button 140 that the user may select to indicate that the prediction of the in-field event was accurate. The dialog box 136 may also include a “NO” selector button 142. In this manner, the user may provide feedback for the prediction of the event.

In the above example, the user feedback is binary (e.g., accurate or inaccurate). Upon selection of the “YES” selector button 140, the ground truth can be set to 100%, and upon selection of the “NO” selector button 142, the ground truth can be set to 0%. A feedback training system adjusts the machine learning model (e.g., adjusting the neurons of a neural network) to output the provided confidence level for the inferred classification.

Feedback provided by one or more users can be weighted to suit a given situation, and/or based on a user's history or reliability. For example, a first soldier who has been sitting in one position for a long time surveying the field environment might have a better view and understanding of the environment than another soldier who is newer to the environment. Accordingly, feedback provided by the first soldier may be weighted more heavily than feedback from the other soldier.

In other examples, the user feedback can be non-binary. For example, the dialog box 136 may additionally or alternatively include an “UNSURE” selector button 156. Selection of the “UNSURE” selection button may not initiate feedback training.

FIG. 8B shows another example of user feedback. In the example of FIG. 8B, a range slider 150 can be configured to receive a percentage or fraction gradient. For example, the user may indicate that they are 50% confident that the soldiers of FIG. 1A are taking fire by setting the range slider to a centered position. A loss function (e.g., in the machine learning model 224 of FIG. 7) may then give the in-field event the user-provided confidence level.

In some examples, the range slider 150 is provided on a graphic selection band 152 that can be visually recognized by the user. For example, the selection band 152 may be wedge shaped and/or the selection band 152 may comprise a color gradient, which the user may be able to recognize faster than reading the text of the selector buttons 140, 142, and 156 of FIG. 8A.

In other examples, a machine learning model may be trained to detect and differentiate between multiple different types of in-field events (e.g., a gunshot or a taser deployment). In such an example, the feedback may additionally or alternatively include a user-provided classification. For example, the user may confirm a prediction of a gunshot, or instead indicate that the prediction is inaccurate by actuating a selector button or other suitable user input mechanism corresponding to another type of in-field event (e.g., taser deployment), or none. In this manner, the user can provide ground truth feedback indicating which of multiple classifications the run-time input represents. The user input feedback is then paired with the run-time input data stream(s) as a feedback training data pair and used to conduct feedback training on the machine learning model.

The tablet computing device 126 may also display a suggestion dialog box 144 including suggestion text 146 indicating a suggested action for the user to take to respond to the in-field event (e.g., “B TEAM FLANK”). The tablet computing device 126 may further display a suggested route 148 for the second team (“B”) 108 to flank the enemy firing position 110. It will also be appreciated that the suggested action may comprise any other suitable action. For example, the suggested action may comprise a recommendation to deploy a weapon (e.g., a mortar or a drone) that can reach the enemy 110. In other examples, the route 148 and/or a target location for the second team (“B”) 108 can be user input (e.g., by a user in the field environment or a user outside of the field). In this manner, one or more users inside and/or outside of the field environment 100 may quickly determine how to respond to the in-field event(s).

The tablet computing device 126 may also display a status of the second team (“B”) 108. For example, based upon a selection of the second team (“B”) 108 on the map 128, the tablet computing device 126 displays a status window 158 indicating a status of the second team 108. The status window 158 may include text 160 indicating that the second team 108 is flanking the enemy position 110. The status window 158 can also include text 162 indicating that two members of the second team 108 are injured.

Similarly, the tablet computing device 126 can display a status of the enemy firing position 110. Based upon a selection of the enemy firing position 110 on the map 128, the tablet computing device 126 displays a status window 164 indicating a status of the enemy. For example, and as introduced above, the AI model(s) 268 of FIG. 7 may be configured to output an inferred number of weapons, type of weapons, and caliber of weapons. Accordingly, the status window 164 may include text 166 indicating that the enemy firing position comprises two gunners and text 168 indicating that they are equipped with 0.50-inch caliber weapons. The status window 164 may include any other suitable information about the enemy firing position 110. For example, the status window 164 may include text 170 indicating that the enemy gunners are reloading their weapons.

With reference now to FIG. 8E, information displayed to a user can be updated as new inputs are received. For example, an AI model may output an initial predicted classification 172 that the enemy firing position is stationary, as indicated in window 174. However, the initial predicted classification 172 may have a relatively low associated confidence 176 (e.g., 49%) when the classification is based on few or unreliable inputs. For example, when the first team 106 and the second team 108 are far away from the enemy firing position or there is poor visibility in the field environment, inputs provided by soldiers in the first team 106 and the second team 108 may be less reliable than inputs provided from a better vantage point or under better visibility conditions.

In contrast, and with reference now to FIG. 8F, the second team 108 has advanced closer to the enemy 110 along the indicated route 148 and is located at a higher elevation. Accordingly, the second team 108 may have a better view of the enemy than in their previous position, and can provide additional, more reliable inputs. The information displayed by the tablet computing device 126 can be updated as the additional inputs are received and processed. For example, the window 174 may include an updated classification 178 indicating that the enemy is retreating. The updated classification 178 may have a higher associated confidence 180 (e.g., 85%) than the confidence 176 of the initial classification. The tablet computing device 126 may also display an arrow 182 indicating a direction in which the enemy is retreating.

In some embodiments, the methods and processes described herein may be tied to a computing system of one or more computing devices. In particular, such methods and processes may be implemented as a computer-application program or service, an application-programming interface (API), a library, and/or other computer-program product.

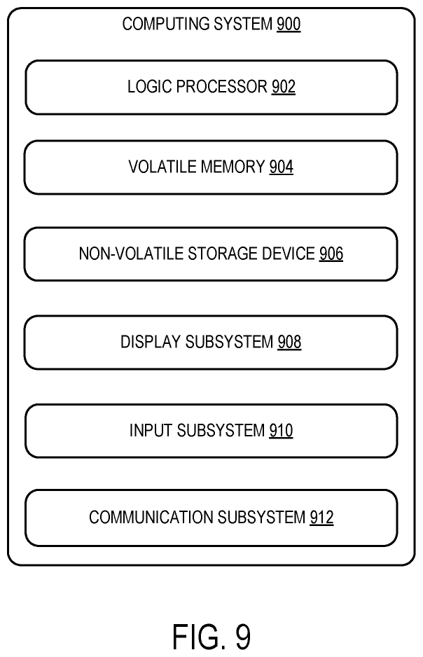

FIG. 9 schematically shows an example of a computing system 900 that can enact one or more of the devices and methods described above. Computing system 900 is shown in simplified form. Computing system 900 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices. In some examples, the computing system 900 may embody the edge computing device 212 of FIG. 2, the computing device 300 of FIG. 3, the weapon 400 of FIG. 4, or the tablet computing device 126 of FIGS. 8A-8F.

The computing system 900 includes a logic processor 902 volatile memory 904, and a non-volatile storage device 906. The computing system 900 may optionally include a display subsystem 908, input subsystem 910, communication subsystem 912, and/or other components not shown in FIG. 9.

Logic processor 902 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 902 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 906 includes one or more physical devices configured to hold instructions executable by the logic processors to implement the methods and processes described herein. When such methods and processes are implemented, the state of non-volatile storage device 906 may be transformed—e.g., to hold different data.

Non-volatile storage device 906 may include physical devices that are removable and/or built-in. Non-volatile storage device 906 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 906 may include nonvolatile, dynamic, static, read/write, read-only, sequential-access, location-addressable, file-addressable, and/or content-addressable devices. It will be appreciated that non-volatile storage device 906 is configured to hold instructions even when power is cut to the non-volatile storage device 906.

Volatile memory 904 may include physical devices that include random access memory. Volatile memory 904 is typically utilized by logic processor 902 to temporarily store information during processing of software instructions. It will be appreciated that volatile memory 904 typically does not continue to store instructions when power is cut to the volatile memory 904.

Aspects of logic processor 902, volatile memory 904, and non-volatile storage device 906 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 typically implemented in software by a processor to perform a particular function using portions of volatile memory, which function involves transformative processing that specially configures the processor to perform the function. Thus, a module, program, or engine may be instantiated via logic processor 902 executing instructions held by non-volatile storage device 906, using portions of volatile memory 904. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 908 may be used to present a visual representation of data held by non-volatile storage device 906. The visual representation may take the form of a graphical user interface (GUI). As the herein described methods and processes change the data held by the non-volatile storage device, and thus transform the state of the non-volatile storage device, the state of display subsystem 908 may likewise be transformed to visually represent changes in the underlying data. Display subsystem 908 may include one or more display devices utilizing virtually any type of technology. Such display devices may be combined with logic processor 902, volatile memory 904, and/or non-volatile storage device 906 in a shared enclosure, or such display devices may be peripheral display devices.

When included, input subsystem 910 may comprise or interface with one or more user-input devices such as a keyboard, mouse, touch screen, or game controller. In some examples, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 912 may be configured to communicatively couple various computing devices described herein with each other, and with other devices. Communication subsystem 912 may include wired and/or wireless communication devices compatible with one or more different communication protocols. For example, the communication subsystem may be configured for communication via a wireless telephone network, or a wired or wireless local- or wide-area network. In some examples, the communication subsystem may allow computing system 900 to send and/or receive messages to and/or from other devices via a network such as the Internet.

FIGS. 10 and 11 show another example environment 1000 in which the embodiments disclosed herein may be applied. In the example environment 1000, an enemy 1002 is firing on an observer 1004 and friendly soldiers 1006 from inside a building 1008. The suggestion model 256 of FIG. 7 may recommend deploying a weapon from a drone 1010 to neutralize the enemy fire.

This suggestion may be refined based upon the proximity of the enemy 1002 to the observer 1004 and friendly soldiers 1006. For example, the suggestion may specify that the drone 1010 should deploy a lightweight precision-guided munition (e.g., an air-to-ground (AGM) missile having a mass of less than 50 pounds), rather than a relatively heavier (e.g., 250 pounds or more) general purpose bomb, which may have a wider blast radius than the lightweight AGM.

The predicted classification 252 of FIG. 7 may additionally or alternatively include a classification of whether a target is eligible to engage or not. Referring to FIG. 11, a baby carriage 1012 is adjacent to the building 1008. The presence of the baby carriage 1012 may be identified by classifying semantic and non-semantic indicators. For example, during a training phase, the observer 1004 may say “there's a civilian”, which may be coupled with a non-semantic auditory indicator, such as a sound of a baby crying, to identify the presence of a civilian non-combatant in the environment 1000. During a run-time phase, the classifier may classify the sound of the baby crying accordingly. Based upon this classification, the suggestion model 256 may recommend that the soldiers 1006 not engage, withdraw, or apply other tactics against the enemy 1002 rather than a drone strike. More generally, the machine learning model 224 may be trained to learn to predict an age of a person from the sound of the person's voice in the audio input, and suggestion model 256 may take as input the predict age of persons in the field, and make a suggestion based upon that predicted age. For example, a suggestion to hold fire may be made by the suggestion model if predicted age of any voice in the audio input is below a predetermined age such as 18.

The following paragraphs discuss several aspects of the present disclosure. According to one aspect of the present disclosure, a method is provided for detecting an in-field event. The method is performed at a computing device. The method comprises, during a training phase, receiving one or more training data streams. The one or more training data streams include an audio input comprising a semantic indicator corresponding to a first instance of the in-field event. The method further comprises processing the audio input of the one or more training data streams to recognize the semantic indicator, selecting a subset of data from the one or more training data streams received within a threshold time of the semantic indicator, using the subset of the data to train a machine learning model to detect the in-field event, and outputting the trained machine learning model. The method further comprises, during a run-time phase, receiving one or more run-time input data streams, using the trained machine learning model to detect a second instance of the in-field event in the one or more run-time input data streams, and outputting an indication of the second instance of the in-field event.

The method may additionally or alternatively include, in response to detecting the second instance of the in-field event, determining a status of a user; and outputting the status of the user. The status of the user may additionally or alternatively include one or more of a location of the user, a direction the user is facing, a weapon status, or biometric data for the user.

The method may additionally or alternatively include, in response to detecting the second instance of the in-field event, determining a status of a group of people; and outputting the status of the group.

The method may additionally or alternatively include, in response to detecting the second instance of the in-field event, generating one or more suggestions for a user to respond to the in-field event; and outputting the one or more suggestions.

Processing the audio input of the one or more training data streams to recognize the semantic indicator may additionally or alternatively include using a natural language processing model to recognize the semantic indicator.

Selecting the subset of the data may additionally or alternatively include selecting one or more of a first portion of the one or more training data streams received before the semantic indicator or a second portion of the one or more training data streams received after the semantic indicator.

Using the subset of the data to train the machine learning model may additionally or alternatively include training the machine learning model to detect a non-semantic auditory indicator of the in-field event.

The one or more training data streams and the one or more run-time input data streams may additionally or alternatively include inertial measurement unit (IMU) data from an IMU coupled to a weapon.

The audio input may be additionally or alternatively received from a microphone array.

The in-field event may additionally or alternatively include a gunshot, and the method may additionally or alternatively include identifying a direction of the gunshot.

The method may additionally or alternatively include outputting the indication of the second instance of the in-field event using one or more of an audio output device, a haptic feedback device, a light, or a display device.

The one or more training data streams and the one or more run-time input data streams may additionally or alternatively include radio frequency data.

According to another aspect of the present disclosure, an edge computing device is provided. The edge computing device comprises a processor and a memory storing instructions executable by the processor. The instructions are executable to, during a training phase, receive one or more training data streams. The one or more training data streams include an audio input comprising a semantic indicator corresponding to a first instance of an in-field event. The instructions are further executable to process the audio input of the one or more training data streams to recognize the semantic indicator, select a subset of data from the one or more training data streams received within a threshold time of the semantic indicator, use the subset of the data to train a machine learning model to detect the in-field event, and output the trained machine learning model. The instructions are executable to, during a run-time phase, receive one or more run-time input data streams, use the trained machine learning model to detect a second instance of the in-field event in the one or more run-time input data streams, and output an indication of the second instance of the in-field event.

The instructions may be additionally or alternatively executable to, in response to detecting the second instance of the in-field event, determine a status of a user; and output the status of the user.

The instructions may be additionally or alternatively executable to, in response to detecting the second instance of the in-field event, generate one or more suggestions for a user to respond to the in-field event; and output the one or more suggestions.

Using the subset of the data to train the machine learning model may additionally or alternatively include training the machine learning model to detect a non-semantic auditory indicator of the in-field event.

According to another aspect of the present disclosure, a system is provided. The system comprises one or more input devices configured to capture one or more training data streams and one or more run-time input data streams. The one or more training data streams include an audio input comprising a semantic indicator corresponding to a first instance of an in-field event. The system further comprises an edge computing device. The edge computing device comprises a processor and a memory storing instructions executable by the processor. The instructions are executable by the processor to, during a training phase, receive the one or more training data streams, process the audio input of the one or more training data streams to recognize the semantic indicator, select a subset of data from the one or more training data streams received within a threshold time of the semantic indicator, use the subset of the data to train a machine learning model to detect the in-field event, and output the trained machine learning model. The instructions are further executable to, during a run-time phase, receive the one or more run-time input data streams, use the trained machine learning model to detect a second instance of the in-field event in the one or more run-time input data streams, and output an indication of the second instance of the in-field event.

The instructions may be additionally or alternatively executable to, in response to detecting the second instance of the in-field event, generate one or more suggestions for a user to respond to the in-field event; and output the one or more suggestions.

Using the subset of the data to train the machine learning model may additionally or alternatively include training the machine learning model to detect a non-semantic auditory indicator of the in-field event.

It will be understood that the configurations and/or approaches described herein are exemplary in nature, and that these specific embodiments or examples are not to be considered in a limiting sense, because numerous variations are possible. The specific routines or methods described herein may represent one or more of any number of strategies. As such, various acts illustrated and/or described may be performed in the sequence illustrated and/or described, in other sequences, in parallel, or omitted. Likewise, the order of the above-described methods may be changed.

The subject matter of the present disclosure includes all novel and non-obvious combinations and sub-combinations of the various methods, systems and configurations, and other features, functions, acts, and/or properties disclosed herein, as well as any and all equivalents thereof.

1. At a computing device, a method for detecting an in-field event, the method comprising:
during a training phase:
receiving one or more training data streams, wherein the one or more training data streams include an audio input comprising a semantic indicator corresponding to a first instance of the in-field event;
processing the audio input of the one or more training data streams to recognize the semantic indicator;
selecting a subset of data from the one or more training data streams received within a threshold time of the semantic indicator;
using the subset of the data to train a machine learning model to detect the in-field event;
outputting the trained machine learning model;
during a run-time phase:
receiving one or more run-time input data streams;
using the trained machine learning model to detect a second instance of the in-field event in the one or more run-time input data streams; and
outputting an indication of the second instance of the in-field event.

2. The method of claim 1, further comprising:
in response to detecting the second instance of the in-field event, determining a status of a user; and
outputting the status of the user.

3. The method of claim 2, wherein the status of the user includes one or more of a location of the user, a direction the user is facing, a weapon status, or biometric data for the user.

4. The method of claim 1, further comprising:
in response to detecting the second instance of the in-field event, determining a status of a group of people; and
outputting the status of the group.

5. The method of claim 1, further comprising:
in response to detecting the second instance of the in-field event, generating one or more suggestions for a user to respond to the in-field event; and
outputting the one or more suggestions.

6. The method of claim 1, wherein processing the audio input of the one or more training data streams to recognize the semantic indicator comprises using a natural language processing model to recognize the semantic indicator.

7. The method of claim 1, wherein selecting the subset of the data comprises selecting one or more of a first portion of the one or more training data streams received before the semantic indicator or a second portion of the one or more training data streams received after the semantic indicator.

8. The method of claim 1, wherein using the subset of the data to train the machine learning model comprises training the machine learning model to detect a non-semantic auditory indicator of the in-field event.

9. The method of claim 1, wherein the one or more training data streams and the one or more run-time input data streams comprise inertial measurement unit (IMU) data from an IMU coupled to a weapon.

10. The method of claim 1, wherein the audio input is received from a microphone array.

11. The method of claim 1, wherein the in-field event comprises a gunshot, the method further comprising identifying a direction of the gunshot.

12. The method of claim 1, further comprising outputting the indication of the second instance of the in-field event using one or more of an audio output device, a haptic feedback device, a light, or a display device.

13. The method of claim 1, wherein the one or more training data streams and the one or more run-time input data streams comprise radio frequency data.

14. An edge computing device comprising:
a processor; and
a memory storing instructions executable by the processor to,
during a training phase:
receive one or more training data streams, wherein the one or more training data streams include an audio input comprising a semantic indicator corresponding to a first instance of an in-field event,
process the audio input of the one or more training data streams to recognize the semantic indicator,
select a subset of data from the one or more training data streams received within a threshold time of the semantic indicator,
use the subset of the data to train a machine learning model to detect the in-field event,
output the trained machine learning model, and
during a run-time phase:
receive one or more run-time input data streams,
use the trained machine learning model to detect a second instance of the in-field event in the one or more run-time input data streams, and
output an indication of the second instance of the in-field event.

15. The edge computing device of claim 14, wherein the instructions are further executable to:
in response to detecting the second instance of the in-field event, determine a status of a user; and
output the status of the user.

16. The edge computing device of claim 14, wherein the instructions are further executable to:
in response to detecting the second instance of the in-field event, generate one or more suggestions for a user to respond to the in-field event; and
output the one or more suggestions.

17. The edge computing device of claim 14, wherein using the subset of the data to train the machine learning model comprises training the machine learning model to detect a non-semantic auditory indicator of the in-field event.

18. A system, comprising:
one or more input devices configured to capture one or more training data streams and one or more run-time input data streams, wherein the one or more training data streams include an audio input comprising a semantic indicator corresponding to a first instance of an in-field event;
an edge computing device comprising,
a processor; and
a memory storing instructions executable by the processor to,
during a training phase:
receive the one or more training data streams,
process the audio input of the one or more training data streams to recognize the semantic indicator,
select a subset of data from the one or more training data streams received within a threshold time of the semantic indicator,
use the subset of the data to train a machine learning model to detect the in-field event,
output the trained machine learning model, and
during a run-time phase:
receive the one or more run-time input data streams,
use the trained machine learning model to detect a second instance of the in-field event in the one or more run-time input data streams, and
output an indication of the second instance of the in-field event.

19. The system of claim 18, wherein the instructions are further executable to:
in response to detecting the second instance of the in-field event, generate one or more suggestions for a user to respond to the in-field event; and
output the one or more suggestions.

20. The system of claim 18, wherein using the subset of the data to train the machine learning model comprises training the machine learning model to detect a non-semantic auditory indicator of the in-field event.
